(19) United States
(12) Patent Application Publication
(10) Pub. No.: US 2026/0330267 A1
(43) Pub. Date: Oct. 22, 2026

(54) ROBUST EXPERT LANGUAGE MODEL FILTERING WITH RIEMANNIAN ARTIFACT DETECTION

(71) Applicant: Dell Products L.P., Round Rock, TX (US)

(72) Inventors: Vinicius Michel Gottin, Rio de Janeiro (BR); Paulo Abelha Ferreira, Rio de Janeiro (BR); Pablo Nascimento da Silva, Niterói (BR)

(21) Appl. No.: 19/181,184

(22) Filed: Apr. 16, 2025

(51) Int. Cl. G06N 5/043

(52) U.S. Cl. CPC G06N 5/043

(57) ABSTRACT

One example method includes receiving a query from a user, providing the query to each domain expert model in a group of domain expert models, each of which generates a respective set of intermediate results, collecting a respective perplexity series generated by each of the domain expert models in connection with the query, generating a covariance matrix based on all of the perplexity series, comparing the covariance matrix with a covariance matrix that defines a baseline for normative behavior of the domain expert models, and based on the comparing, using an iterative pruning approach to identify, and remove, any of the domain expert models that are not operating within their respective domain.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to language models and associated prompts. More particularly, at least some embodiments relate to systems, hardware, software, computer-readable media, and methods for robust expert language model filtering with Riemannian artifact detection.

### BACKGROUND

Scenarios often arise in which a set of n “expert,” that is, small, pretrained, domain-specific, language models M₁, M₂ . . . Mₙ are potentially invoked to generate at least part of the prompt of a larger general language model G. This scenario may be important for a wide range of applications in which prompt generation relies on preset models and fine-tuning is undesirable or not possible, and in circumstances in which the datasets used to train the expert models are not accessible and therefore cannot be used for indexing and retrieval, as in RAG (retrieval automated generation approaches.

In this example, the performance of the general model G is predicated on its capacity to accurately select the relevant content generated from each of the expert models M₁, M₂ . . . Mₙ. In typical applications, a ranking or filtering of the content, that is, the respective outputs of these expert models, is performed. One typical application may entail additional general language model invocations to rank and/or assess the relevance of each expert model output for the prompt-generation task at hand, for example, which can be costly. Furthermore, these approaches may not be robust to changes in the expert model parameters, such as the “temperature” for text generation.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a prediction of a next token and rank computation.

FIG. 2 discloses aspects of a general representation of the usage of n expert models to compose the prompt P to a general model G.

FIG. 3 discloses an approach in which a module z adaptively identifies and selects the appropriate domain expert models only, for example M₂ and Mₙ, according to one embodiment.

FIG. 4 discloses a table containing the (binary) relevance of each prompt to each domain, that is, each domain expert model, according to one embodiment.

FIG. 5 discloses an approach for obtaining a set of prompts P_{i,j} relevant for both models Mᵢ, Mⱼ (in the example, M₂, M₃) by filtering [symbol] , according to one embodiment.

FIG. 6 discloses an approach for prompting models Mᵢ, Mⱼ with the prompt pₓ according to P_{i,j} and obtaining the respective probability (or perplexity) series

$${S}_{i}^{x} , {S}_{j}^{x} -$$

in this example case, x=1 and i, j=2, 3, according to one embodiment.

FIG. 7 discloses an example of a paired series of probabilities (perplexities) for a pair of models M_{i,j} according to one embodiment.

FIG. 8 discloses the overlapping generation of

$${S}_{2}^{4}$$

respective P_{1,2} and P_{2,3} according to one embodiment.

FIG. 9 discloses an example of the parallel prompting of each expert model with the query, obtaining the perplexity series, according to one embodiment.

FIG. 10 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to language models and associated prompts. More particularly, at least some embodiments relate to systems, hardware, software, computer-readable media, and methods for robust expert language model filtering with Riemannian artifact detection.

One or more example embodiments comprise a method and architecture for generating composite prompts for a general language model (LM) such as an LLM (large language model) for example. These composite prompts may be generated based on respective prompts generated for a group of models. The group of models may be selected from a candidate group of models whose relevance, or not, to the LM, may be determined using an artifact detection algorithm. Candidate models that meet or exceed an acceptance threshold, as determined by artifact detection, are deemed domain experts whose respective prompts are relevant to the LM and may be used in generation of the composite prompt.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect is that an embodiment may dynamically select appropriate domain-expert models for composite prompt generation. An embodiment may select domain-expert models without relying on RAG (Resource Augmented Generation) datasets. An embodiment is adaptable to changes in the domain expert models. Various other advantages of one or more example embodiments will be apparent from this disclosure.

### A. REFERENCES

Reference is made herein to various documents. These are listed below and are incorporated herein in their respective entireties by this reference.
[1] HuggingFace, “Hugging Face documentation,” [Online]. Available: https://huggingface.co/docs/transformers/perplexity.
[2] C. S. K. Valmeekan, K. Narayanan, D. Kalathil, J. Chamberland, S. Shakkottai, “LLMZip: Lossless Text Compression using Large Language Models,” 6 Jun. 2023. [Online]. Available: https://arxiv.org/abs/2306.04050.

### B. Aspects of an Example Context for One or More Embodiments

The following is a discussion of aspects of example operating contexts for various embodiments. This discussion is not intended to limit the scope of the claims or this disclosure, or the applicability of the embodiments, in any way.

### B.1 Perplexity in Large Language Models (LLMs)

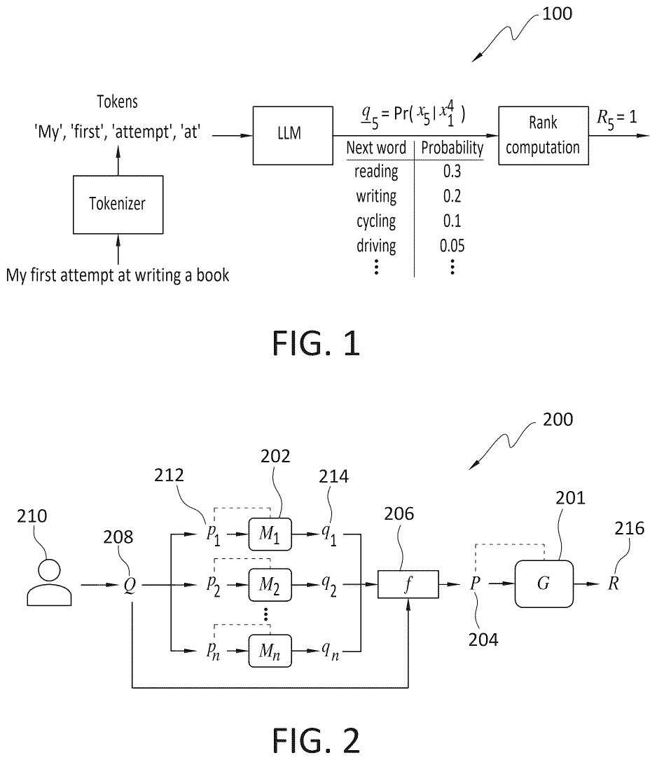

Perplexity (PPL) is one of the metrics that may be used for evaluating language models. ‘Perplexity’ captures how well the LLM can predict the tokens in the text—and stores, for each token, a measure of the “surprise” of the model when predicting that token. The prediction, by an LLM, of a next token in a sentence, following a prefix (comprising previous words) is depicted in the example of FIG. 1 (see [2]) which discloses a process 100 for token prediction.

It is noted that the LLM is trained with a vast amount of data and optimized to create a model that minimizes perplexity. In reference [2], this mechanism is used to obtain a sequence of ranks that are then input to a standard compression mechanism, exploiting the high number of low ranks in the sequence.

With this context in view, one or more embodiments operate to leverage the sequence of probabilities for determining normative behavior for specialist, or domain expert, LMs. This may enable determination as to when a model is not suitable as a ‘domain expert’ for a certain prompt.

### B.2 Riemannian Potato

The “Riemannian Potato” is a time series artifact detection technique that has applications in many domains, especially in those with noisy data such as, for example, GPS, radar, and electroencephalography. In this method, the signal is split into time windows and transformed into covariance matrices that relate the signal features/channels. These are used as sample data descriptors, which are of reduced dimension, compared to the original data, to define a “region of normality” on the covariance space. Following is a formal definition.

Because covariance matrices lie on a Symmetric Positive Definite (SPD(n)) space, using usual straight-line distance metrics such as Euclidean distance can lead to non-admissible covariance matrices, which would have negative eigenvalues and leave the SPD(n) cone. Thus, an embodiment may adopt a curve distance metric. Since the SPD(n) space is differentiable, it is possible to “break down” the neighborhood around each covariance matrix C into a local linearization of that space, called tangent space, where an embodiment may apply a Riemannian metric. By choosing a Riemannian metric on each tangent space, an embodiment may easily calculate the distance between covariance matrices following geodesics, that is, the shortest path between two points in a manifold.

The Riemannian Potato method calculates the Riemannian distance of each new sample covariance matrix to a reference matric C and decides, based on a given z-score, if this sample is to be considered anomalous or not.

For example, let x(t) be a zero-centered multivariate signal composed of N channels, each representing a different time series. Let xₖ be the k^{th} time-window under consideration such that xₖ=[x₁ₖ, . . . , x_{Nk}]^{T} where xᵢₖ∈ [symbol] ^{T}, i∈1, . . . , N corresponds to k^{th} time-window of the i^{st} channel containing T of its time step values such that xₖ∈ [symbol] . The k^{th} sample covariance matrix of x(t) is given by

$${C}_{k} = \frac{1}{N - 1} {x}_{k} {x}_{k}^{T}$$

with Cₖ∈ [symbol] .

As for illustrating the case for N=2, this would be:

$${C}_{k} = ( \begin{matrix}Var ( {x}_{1 k} ) & Cov ( {x}_{1 k} , {x}_{2 k} ) \\ Cov ( {x}_{2 k} , {x}_{1 k} ) & Var ( {x}_{2 k} )\end{matrix} )$$

The Riemannian metric used in the Riemannian Potato algorithm is the Fisher-Rao metric, which amounts to the following distance value:

$$δ ( \overline{C} , {C}_{k} ) = \sqrt{{\sum }_{n = 1}^{N} {log}^{2} {λ}_{n}}$$

with λₙ being the eigenvalues of C̅⁻¹Cₖ.

Let C̅ be the reference covariance matrix that equals the geometric mean of a training set {C₁, . . . , Cₘ} containing the first m covariance matrices of the signal x(t). A sample covariance matrix Cⱼ, j>m is considered anomalous if the z-score of Cⱼ is greater than a user-defined threshold z, that is:

$$\frac{δ ( \overline{C} , {C}_{j} ) - μ}{σ} > z$$

where μ, σ are the mean and standard deviations of the distance to the reference matrix in the training set.

### C. Overview of Aspects on One or More Embodiments

One or more example embodiments consider the scenario in which a set of n “expert,” that is, small, pretrained, domain-specific, language models M₁, M₂, . . . , Mₙ are potentially invoked to generate part of the prompt of a larger general language model G. This scenario is important for a wide range of applications in which generation relies on preset models and fine-tuning is undesirable or not possible; and in which the datasets used to train the expert models are not accessible, and therefore cannot be used for indexing and retrieval, in RAG approaches. It is envisioned that this latter case may become the norm as conversational chatbots and agents become more widely adopted and domain-expert LLMs are provided “as a service,” with no access provided to the underlying data.

Within the constraints of:
1. not performing any training of an ensemble or ‘mixture of experts’ model;
2. leveraging only off-the-shelf expert models such that their training sets are not accessible;
3. not having access to the domain-specific data—therefore rendering RAG approaches unfeasible; and
4. not relying on potentially expensive ranking/assessment approaches,
   one or more embodiments comprise an approach to determine, in online fashion, which subset of expert models are relevant for a current prompt-generation task.

One or more embodiments may extend and adapt an approach for noise-robust anomalous signal detection, originally proposed for artifact detection in time series domains. An embodiment may take the series of the probabilities assigned to each token—the perplexity values—of each domain-expert language model. An embodiment may then apply an artifact detection algorithm, such as the “Riemannian Potato” for example, which considers the pairwise covariances between those series.
1. OFFLINE—In an offline stage, an embodiment uses the perplexity series stemming from prompts known to be from appropriate domains for the models, that is, corresponding to the models' expertise—an embodiment obtains a covariance matrix A that determines a baseline for normative behavior; and
2. ONLINE—In an online operation, an embodiment takes the perplexity series of all expert models for a new incoming prompt. This ultimately yields a covariance matrix B.

The comparison between the covariances in the baseline normative behavior in A and the current prompt B yields a distance in Riemannian space. A large distance means that the covariances are outside the norm. In an embodiment, this is taken as an indication that one or more of those models are not operating within their respective domain(s), such that those models should not be used as an expert model for this prompt.

An embodiment may perform an iterative approach in which one or more ‘culprit’ models are identified. This approach involves determining the relevant dimension(s) in the model that most contribute to that distance, wherein each dimension refers to a pair of models. An embodiment may remove the necessary dimensions and recompute the distance—until that distance falls below an acceptance threshold. The remaining dimensions determine the models to be used as domain experts for this prompt.

Thus, one or more embodiments comprise a method for dynamically selecting appropriate domain-expert models for composite generation, without relying on Resource Augmented Generation of datasets, which may have been used to train those models. An embodiment of the method is partially robust to changes in the domain expert models. An approach according to one embodiment stands in contrast with ‘domain-specific’ RAG systems in that such embodiment assumes the datasets used for training the expert models are unreachable, that is, inaccessible/unavailable for purposes of determining a prompt.

### D. Detailed Discussion

### D.1 Context

With reference to the example schema 200 disclosed in FIG. 2, an embodiment may enable a general Large Language Model G 201—which may be resource intensive, with a large context windows- to leverage the inputs of domain expert models M₁, M₂, . . . generally indicated at 202. The latter may typically comprise smaller Language Models, fine-tuned to a domain-specific dataset. That is, n expert models 202 may be used to compose the prompt P 204 to a general model G 201. To achieve high quality from the general model G, a heavy burden is placed on the prompt-building process f 206. As shown, generation of the prompt P 204 is based on a query 208 posed by a user 210.

The example schema 200 of FIG. 2 represents the most general case. The concepts are as follows:
a query Q 208 is provided by the user 210, possibly modified by contextual information such as, but not limited to, conversation history, and data from retrieved sources(s) in RAG-based applications;
this query Q 208 is used to build respective prompts p₁, p₂, . . . , pₙ, generally indicated at 212, for each of the corresponding models M₁, M₂, . . . , Mₙ 202;
each such prompt pᵢ 212 may include Q plus other model-specific instructions—represented by a dashed line—otherwise, the prompt-building processes may be abstracted for each model 202;
the intermediate results q₁, q₂, . . . , qₙ 214 of each of the models 202 are combined, via a prompt-building process f 206 into a prompt P 204 for model G 201; and
the model G 201 produces a response R 216, that is, to the query Q 208, for further reasoning and/or returning to the user 210.

In a baseline approach according to one embodiment, a burden is placed on the prompt-building process f 206. Particularly, that process may operate to filter, rank, and otherwise assess the ‘relevance’ of each individual intermediate result qᵢ 214.

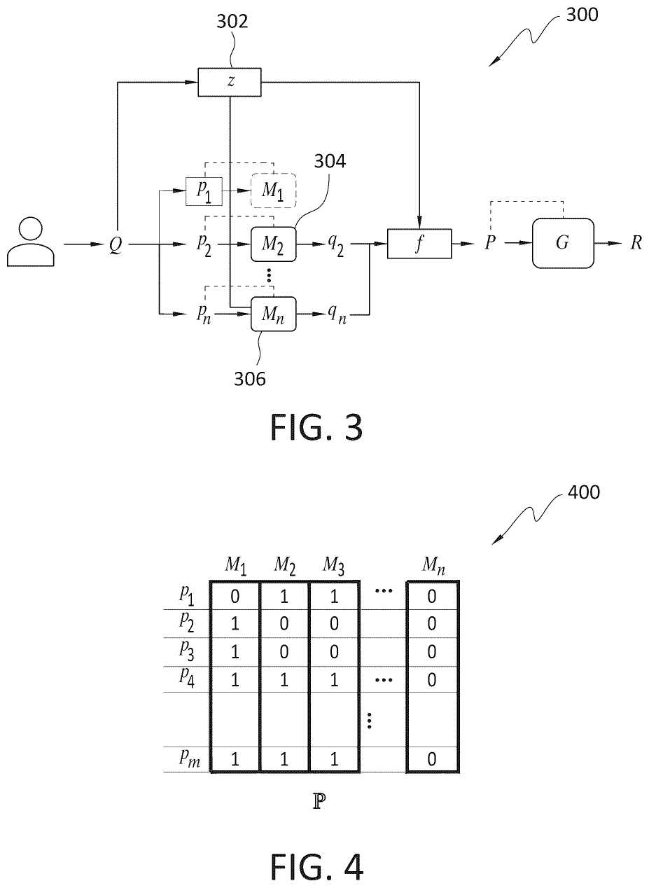

Thus, an embodiment may adaptively select the models that will provide the intermediate results—with an artifact detection approach to identify which expert models are relevant for a given query Q. An example schema 300 for this implementation is disclosed in FIG. 3 and employs a module z 302 that adaptively identifies and selects the appropriate domain expert models 304 and 306 only, for example, M₂, Mₙ (M₁ is not selected in this example) thus lifting, from the prompt-building process f 206 (see FIG. 2), the burden of assessment, ranking, and filtering of inappropriate intermediate results (q₁).

The module z 302 may comprise an adaptation and extension of the Riemannian artifact detection approach to deal with series of the perplexities of tokens in the domain expert LMs. The approach works by determining the normative behavior of the system from the covariances of multiple series captured in normative behavior. Hence, in an embodiment, the covariances considered are those between the series of perplexity of the predicted tokens in the expert LMs when they are known to be applicable. The next sections discuss a process for building and operationalizing an embodiment of the module z 302.

### D.2 Offline Processing

### D.2.1 Domain-Relevance Dataset

An embodiment may begin by obtaining a set of prompts [symbol] ={a₁, a₂, . . . } for which the respective relevance to each of the domain expert models M₁, M₂, . . . , Mₙ is known. In certain scenarios, the datasets used to train the models may be known—but those may not be typical cases, and would raise RAG-based approaches as alternatives to the usage of expert models, as discussed above. In some scenarios, therefore, an embodiment may obtain this dataset, in various ways:
via manual annotations—which may be possible in certain cases, albeit expensive (and likely prohibitively so) in many others; and/or
via a (semi-)automatic generation process—one embodiment envisions a process of generation relying on successive invocations domain expert models, guided by the general model G. Such approaches may be feasible for known domains. Alternatively, the assumption that datasets used to train the expert models are unreachable may be relaxed. In this latter case, retrieval-augmented generation (RAG) based on a set, even if the set is small, of reachable documents of the expert domain may suffice to generate appropriate prompts. This may require substantial orchestration to ensure that prompts are relevant for multiple models, that is, this approach may require a strategy for combination of sources.

Regardless of the method, an embodiment may compose a set [symbol] of prompts, relating the relevance of each prompt p∈ [symbol] to each available domain-expert model, as shown in the table 400 in FIG. 4. That is, the table [symbol] 400 containing the (binary) relevance of each prompt p to each domain, that is, each domain expert model M. FIG. 4 represents a ‘binary’ value for the relevance—this is a particular example case in which a prompt p is either relevant to a particular model M (value 1), or a prompt p is not relevant to a particular model (value 0) M.

Other embodiments are possible where the relevance of the prompt to a domain is given as a score, for example, falling in the range 0 to 1. In that case, a threshold for determining ‘relevance’ may be defined for all models, or a respective threshold for each particular model. It is noted that the dataset may be obtained, or generated, relating the prompts to domains—an embodiment may assume known relations between the models and domains, however, so it can be assumed, for this embodiment, that [symbol] can relate prompts and models directly.

### D.2.2 Normative Behavior Covariance Matrix

The table [symbol] 400 may be used to determine what the normative behavior for the models is like. An embodiment may consider the covariances of the perplexities of the models in pairwise fashion, as in the approach described earlier herein.

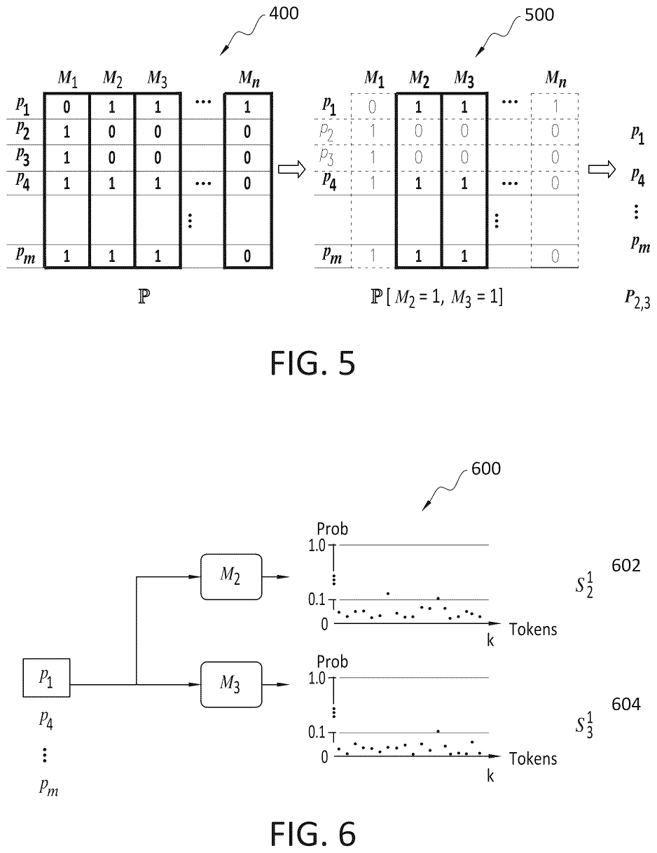

For each pair of models Mᵢ, Mⱼ, an embodiment may filter the table [symbol] 400 such that only the prompts relevant for both, although possibly for other models, are left. This is disclosed in in FIG. 5, which discloses obtaining a set of prompts P_{i,j} relevant for both models Mᵢ, Mⱼ (in the example, M₂, M₃) by filtering the table P 400 to obtain a filtered table P 500.

In an embodiment, the filtering process reflected in FIG. 5 may be relatively straightforward. In particular, for each p∈P_{i,j} an embodiment may compute the probabilities, or perplexities, for the first k tokens—this computation may be performed for both the models Mᵢ and Mⱼ. As disclosed in the schema 600 of FIG. 6, each computation for the example models M₂ and M₃ yields a respective series 602, and 604. That is, FIG. 6 discloses prompting models Mᵢ, Mⱼ with the prompt pₓ according to P_{i,j} and obtaining the respective probability (or perplexity) series

$${S}_{i}^{x} , {S}_{j}^{x} -$$

in this case, x=1 and i, j=2, 3.

It is noted that FIG. 6 does not disclose the prompt-building process for each individual model, which may in some embodiments be assumed to be known and straightforward, as indicated by the dashed lines shown in FIGS. 2 and 3. Rather, FIG. 6 discloses the series S 602 and 604 of probabilities obtained for the first k tokens in each of the models, described earlier herein. It is noted that an embodiment may likewise represent the series of perplexity scores, with no change in meaning or in other embodiments of the disclosed approach. If one of the models does not produce at least k tokens, before an ‘end’ token for example, a padding strategy may be adopted, or the pair of series may be discarded, that is, this may be equivalent to assuming that the prompt p was not in relevant for that model.

The disclosed in FIG. 6 may be performed for all pₓ, p_{y}, . . . in P_{i,j}. Thus, an embodiment may ultimately obtain pairs of series

$$( {S}_{i}^{x} , {S}_{j}^{x} ) , ( {S}_{i}^{y} , {S}_{j}^{y} ) , …$$

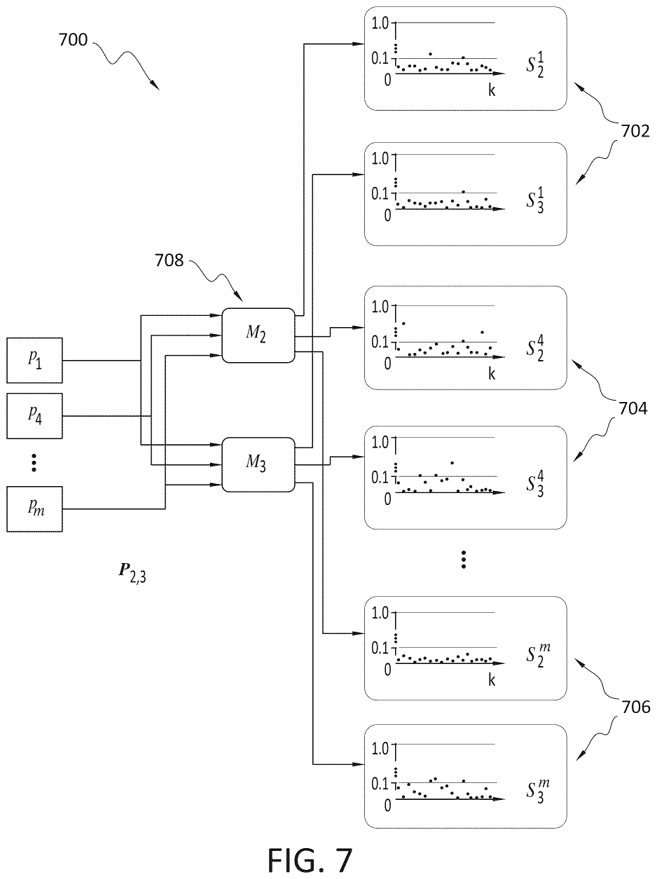

as disclosed in the example schema 700 of FIG. 7 which discloses, in particular, respective paired series 702, 704, and 706, of probabilities (perplexities) for a pair of models M_{i,j} 708, namely, M₂ and M₃ in the example of FIG. 7. These series 702, 704, and 706, may be considered in pairwise fashion for obtaining the covariances in these predetermined fixed-length series.

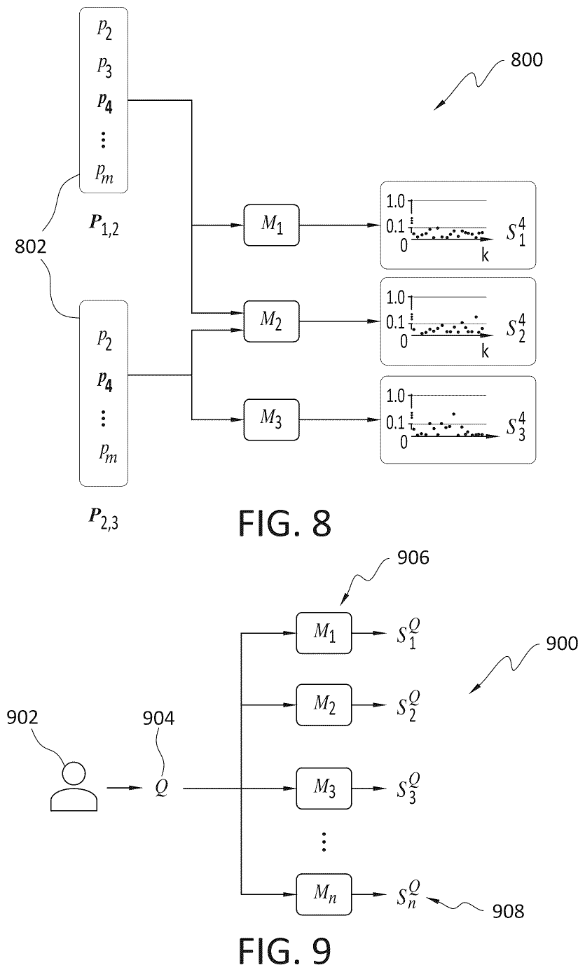

Reference is made briefly to the method described above, in which the multiple ‘channels’ are split into fixed-length windows. One embodiment may interpret each pair of series as a ‘window’ to compute the covariances between the values for these two models, or ‘channels.’ It is noted that the operations above, as shown in FIGS. 6 and 7 for example, are performed for each pair Mᵢ,Mⱼ. Although this can be computationally expensive, it is performed offline in one or more embodiments and so does not impose a burden on prompt generation. Furthermore, memoization of results for prompts that are relevant to more than 2 models is possible. This is disclosed in the example schema 800 of FIG. 8, which discloses an overlapping generation of

$${S}_{2}^{4}$$

for P_{1,2} and P_{2,3}, respectively.

With reference to the example of FIG. 8, it is noted that prompt p₄ 802 is relevant to models M₂ and M₃ but also for model M₁. This means that, in this example, once

$${S}_{2}^{4}$$

has been generated for a model, it does not have to be re-generated, so long as it can be stored in memory. Moreover, the example of FIG. 8 highlights another difference between the present approach and the method described in the Riemannian potato discussion above. In that approach, every window of every ‘channel’ is matched with all concurrent windows for all other channels—for computing covariances. In contrast, one embodiment does not match a perplexity series

$${S}_{x}^{1}$$

to a series

$${S}_{y}^{1}$$

if the prompt p₁ is not relevant to the model M_{y}. Hence, the covariances computed in one embodiment are ‘conditioned’ on the prompts being relevant to the normative behavior of the models. The result of the Riemannian potato method in this case is a covariance matrix M of dimensions n×n, recalling that n is the number of domain expert models, determining the normative behavior for the set of models. An embodiment may leverage this, as in the original approach, for the online ‘normativeness check’ that enables a model-filtering and selection process, according to one embodiment.

### D.3 Online Operations

An embodiment may assume the expert models and the general model G deployed, as in. Then, an embodiment may receive a new query Q by the user and aim to determine which of the expert models should be used by the general model for composing an expert-validated answer.

### D.3.1 Normativeness Check

In an embodiment, and with reference to the example schema 900 of FIG. 9, the normativeness check may be performed as follows. A query Q 904 from a user 902 is provided as input to each of the expert models 906 in parallel, and the respective perplexity series 908 for each of the expert models 906 is collected. This is disclosed in FIG. 9 which shows the parallel prompting of each expert model 906 with the query 904, obtaining the respective perplexity series 908.

As described earlier herein, an embodiment may abstract the prompt-building processes for each of the models. It may or may not be assumes that the series S are of similar size in this case—the responses by the models may vary in length. An embodiment may thus process each of the series in windows of k tokens, as in the offline processing, with a similar padding strategy adopted, if any, for the latter windows. Alternatively, an embodiment may perform the check up until the number of tokens of the smallest answer is reached—at which point it may be considered that all remaining models are ‘normative’ and do not require further filtering.

In an example case, for an aligned window of the series

$${S}_{1}^{Q} , … , {S}_{n}^{Q} ,$$

an embodiment may compute the pairwise covariance matrix W for that window. This is exactly as in the original Riemannian Potato artifact detection method. Each such matrix can be interpreted as a point living on a smooth manifold (SPD(n)). If this point is within bounds, that is, the distance between that point and the origin is within a threshold, according to the Riemannian distance metric adopted, it may be considered that all models are relevant and applicable. Otherwise, if the distance between that point and the origin exceeds the threshold, an embodiment may perform an iterative pruning process, an example of which is described below.

### D.3.2 Iterative Normative Search Process

In an embodiment, the iterative pruning seeks to determine which of the models, having been discarded, would result in a ‘normative’ covariance for the remaining models. An embodiment may compute the eigenvalues of the matrix W in the Riemannian metric. The largest eigenvalues are interpreted as ‘contributing’ the most for the excessive distance between the point (given by W) and the normative behavior (given by the Riemannian Potato expressed by [symbol] ).

Recall that each ‘dimension’ in this space represents the covariance of a pair of models. An embodiment may check which models are most-present in the most ‘contributing’ dimensions for the excess over the threshold, that is, which models are associated to the most dimensions with the largest eigenvalues. This selection process may take many forms, as there may be multiple choices of models that ‘contribute’ the most, and distance may be invariant to any order of dimensions. An embodiment may assume the selection of any of the ‘top count’ models to be sufficient, with the purpose being to ‘eliminate’ one of the ‘culprit’ models for the covariances being ‘non-normative.’

After removing the model—such as by zeroing out all rows and columns in W for dimensions associated with that model—an embodiment may recompute the respective distance to the W and [symbol] . If that distance falls below the threshold, all remaining models are considered relevant. Otherwise, one or more additional iteration(s) of the iterative pruning process may be performed.

### D.3.3 Application—Intermediate Result Filtering

An embodiment may thus be able to identify which model(s) may be operating outside their area of expertise, as indicated by hallucinations generated by those models, by the comparative expected normativeness of the covariances between all pairs of models. Recall from the example of FIG. 3 discussed above that the intermediate results of models that are considered ‘not relevant’ are discarded and not provided to the prompt-building process f. This relieves the burden of that prompt-building process f of having to deal with irrelevant results, and the overall system of having to perform advanced, and likely costly, ‘response analysis’ processes over the result R of model G.

Methods according to various embodiments may be particularly useful since the covariances are robust to noise in the underlying series, which is a significant advantage of the Riemannian Potato approach. Thus, an embodiment based on the same principles as the Riemannian Potato approach may be resilient to minor differences in parametrization, such as in the temperature parameter of the language models, or even in model versioning such as pre- and post-minor finetuning of an expert model, for example.

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments. These are presented only by way of example and are not intended to limit the scope of this disclosure or the claims in any way.

Embodiment 1. A method, comprising: A method for identifying which language model prompts, as among a group of language model prompts, are most relevant for use in creating a composite prompt to generate a response to a user inquiry, comprising: receiving a query from a user; providing the query to each domain expert model in a group of domain expert models, each of which generates a respective set of intermediate results; collecting a respective perplexity series generated by each of the domain expert models in connection with the query;
generating a covariance matrix based on all of the perplexity series; comparing the covariance matrix with a covariance matrix that defines a baseline for normative behavior of the domain expert models; and based on the comparing, using an iterative pruning approach to identify, and remove, any of the domain expert models that are not operating within their respective domain.

Embodiment 2. The method as recited in claim 1, wherein the comparing yields a distance in Riemannian space, and the domain expert models are considered as operating within their domain when the distance does not exceed a threshold.

Embodiment 3. The method as recited in claim 1, wherein the comparing yields a distance in Riemannian space, and the iterative approach comprises removing dimension(s) of the domain expert models that contribute most to the distance until the distance falls below a threshold.

Embodiment 4. The method as recited in claim 3, wherein each of the dimensions represents a covariance of a respective pair of the domain expert models.

Embodiment 5. The method as recited in claim 1, wherein the comparing yields a distance in Riemannian space, and the distance is a distance between an origin of a smooth manifold, and a point in the smooth manifold defined by the covariance matrix.

Embodiment 6. The method as recited in claim 1, wherein only the respective intermediate results of the domain expert models remaining after completion of the iterative pruning approach are used to generate a composite prompt for a language model that is configured to generate, based on the composite prompt, a response to the user query.

Embodiment 7. The method as recited in claim 1, wherein the covariance matrix that defines the baseline for normative behavior of the domain expert models is generated based on circumstances in which the domain expert models are known to be applicable to a user query.

Embodiment 8. The method as recited in claim 1, wherein each of the intermediate results comprise a respective prompt for one of the domain expert models, and the covariance matrix that defines the baseline for normative behavior of the domain expert models comprises information indicating which of the prompts apply to which of the domain expert models.

Embodiment 9. The method as recited in claim 1, wherein the perplexity series for a given one of the domain expert models captures an extent to which that domain expert model is able to predict tokens in the query.

Embodiment 10. The method as recited in claim 1, wherein the iterative pruning approach comprises using a Riemannian Potato time series artifact detection technique.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform anyone or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

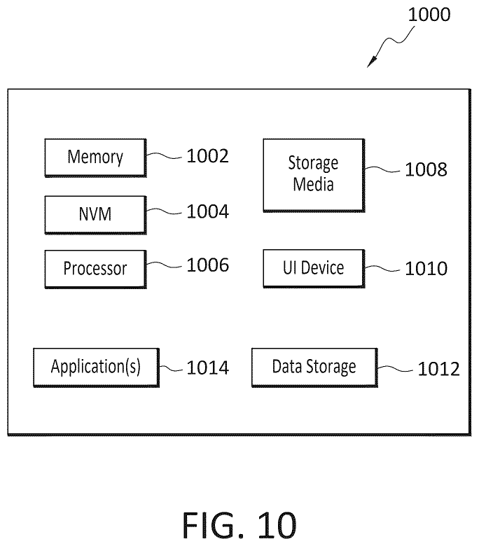

With reference briefly now to FIG. 10, any one or more of the entities disclosed, or implied, by FIGS. 1-9 and/or elsewhere herein, may take the form of, or include, or be implemented on, or hosted by, a physical computing device, one example of which is denoted at 1000. As well, where any of the aforementioned elements comprise or consist of a virtual machine (VM), that VM may constitute a virtualization of any combination of the physical components disclosed in FIG. 10.

In the example of FIG. 10, the physical computing device 1000 includes a memory 1002 which may include one, some, or all, of random access memory (RAM), non-volatile memory (NVM) 1004 such as NVRAM for example, read-only memory (ROM), and persistent memory, one or more hardware processors 1006, non-transitory storage media 1008, UI device 1010, and data storage 1012. One or more of the memory components 1002 of the physical computing device 1000 may take the form of solid state device (SSD) storage. As well, one or more applications 1014 may be provided that comprise instructions executable by one or more hardware processors 1006 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for identifying which language model prompts, as among a group of language model prompts, are most relevant for use in creating a composite prompt to generate a response to a user inquiry, comprising:
receiving a query from a user;
providing the query to each domain expert model in a group of domain expert models, each of which generates a respective set of intermediate results;
collecting a respective perplexity series generated by each of the domain expert models in connection with the query;
generating a covariance matrix based on all of the perplexity series;
comparing the covariance matrix with a covariance matrix that defines a baseline for normative behavior of the domain expert models; and
based on the comparing, using an iterative pruning approach to identify, and remove, any of the domain expert models that are not operating within their respective domain.

2. The method as recited in claim 1, wherein the comparing yields a distance in Riemannian space, and the domain expert models are considered as operating within their domain when the distance does not exceed a threshold.

3. The method as recited in claim 1, wherein the comparing yields a distance in Riemannian space, and the iterative approach comprises removing dimension(s) of the domain expert models that contribute most to the distance until the distance falls below a threshold.

4. The method as recited in claim 3, wherein each of the dimensions represents a covariance of a respective pair of the domain expert models.

5. The method as recited in claim 1, wherein the comparing yields a distance in Riemannian space, and the distance is a distance between an origin of a smooth manifold, and a point in the smooth manifold defined by the covariance matrix.

6. The method as recited in claim 1, wherein only the respective intermediate results of the domain expert models remaining after completion of the iterative pruning approach are used to generate a composite prompt for a language model that is configured to generate, based on the composite prompt, a response to the user query.

7. The method as recited in claim 1, wherein the covariance matrix that defines the baseline for normative behavior of the domain expert models is generated based on circumstances in which the domain expert models are known to be applicable to a user query.

8. The method as recited in claim 1, wherein each of the intermediate results comprise a respective prompt for one of the domain expert models, and the covariance matrix that defines the baseline for normative behavior of the domain expert models comprises information indicating which of the prompts apply to which of the domain expert models.

9. The method as recited in claim 1, wherein the perplexity series for a given one of the domain expert models captures an extent to which that domain expert model is able to predict tokens in the query.

10. The method as recited in claim 1, wherein the iterative pruning approach comprises using a Riemannian Potato time series artifact detection technique.

11. A non-transitory storage medium having stored therein instructions that are executable by one or more hardware processors to perform operations comprising:
receiving a query from a user;
providing the query to each domain expert model in a group of domain expert models, each of which generates a respective set of intermediate results;
collecting a respective perplexity series generated by each of the domain expert models in connection with the query;
generating a covariance matrix based on all of the perplexity series;
comparing the covariance matrix with a covariance matrix that defines a baseline for normative behavior of the domain expert models; and
based on the comparing, using an iterative pruning approach to identify, and remove, any of the domain expert models that are not operating within their respective domain.

12. The non-transitory storage medium as recited in claim 11, wherein the comparing yields a distance in Riemannian space, and the domain expert models are considered as operating within their domain when the distance does not exceed a threshold.

13. The non-transitory storage medium as recited in claim 11, wherein the comparing yields a distance in Riemannian space, and the iterative approach comprises removing dimension(s) of the domain expert models that contribute most to the distance until the distance falls below a threshold.

14. The non-transitory storage medium as recited in claim 13, wherein each of the dimensions represents a covariance of a respective pair of the domain expert models.

15. The non-transitory storage medium as recited in claim 11, wherein the comparing yields a distance in Riemannian space, and the distance is a distance between an origin of a smooth manifold, and a point in the smooth manifold defined by the covariance matrix.

16. The non-transitory storage medium as recited in claim 11, wherein only the respective intermediate results of the domain expert models remaining after completion of the iterative pruning approach are used to generate a composite prompt for a language model that is configured to generate, based on the composite prompt, a response to the user query.

17. The non-transitory storage medium as recited in claim 11, wherein the covariance matrix that defines the baseline for normative behavior of the domain expert models is generated based on circumstances in which the domain expert models are known to be applicable to a user query.

18. The non-transitory storage medium as recited in claim 11, wherein each of the intermediate results comprise a respective prompt for one of the domain expert models, and the covariance matrix that defines the baseline for normative behavior of the domain expert models comprises information indicating which of the prompts apply to which of the domain expert models.

19. The non-transitory storage medium as recited in claim 11, wherein the perplexity series for a given one of the domain expert models captures an extent to which that domain expert model is able to predict tokens in the query.

20. The non-transitory storage medium as recited in claim 11, wherein the iterative pruning approach comprises using a Riemannian Potato time series artifact detection technique.
